(19) United States
(12) Patent Application Publication
(10) Pub. No.: US 2025/0274460 A1
(43) Pub. Date: Aug. 28, 2025

(54) METHOD AND DEVICE FOR PROCESSING DATA ASSOCIATED WITH A COMMUNICATION SYSTEM

(71) Applicant: Robert Bosch GmbH, Stuttgart (DE)

(72) Inventors: Arthur Mutter, Neuhausen (DE); Friedrich Wiemer, Burgstetten (DE); Ramona Jung, Stuttgart (DE); Thomas Enderle, Muenchen (DE)

(21) Appl. No.: 19/042,044

(22) Filed: Jan. 31, 2025

(30) Foreign Application Priority Data
Feb. 22, 2024 (DE) 10 2024 201 665.9

(51) Int. Cl. H04L 9/40

(52) U.S. Cl. CPC H04L 63/1416; H04L 63/1425

(57) ABSTRACT

A method for processing data associated with a communication system. The method includes: managing a set of, for example, one or more, values for a first parameter which characterizes a timeliness of a message that can be received via the communication system, wherein for example, the set has at least one first subset that has, for example one or more, possible values for the first parameter and at least one second subset that has, for example one or more, historical values for the first parameter, evaluating a parameter value of the received message characterizing a timeliness of a message received via the communication system based on the set.

### CROSS REFERENCE

The present application claims the benefit under 35 U.S.C. § 119 of German Patent Application No. DE 10 2024 201 665.9 filed on Feb. 22, 2024, which is expressly incorporated herein by reference in its entirety.

### FIELD

The present invention relates to a method for processing data associated with a communication system.

The present invention relates to a device for processing data associated with a communication system.

### SUMMARY

Some examples relate to a method, for example a computer-implemented method, for processing data associated with a communication system, comprising: managing a set of, for example, one or more, values for a first parameter which characterizes a timeliness of a message that can be received via the communication system, wherein for example, the set has at least one first subset that has, for example one or more, possible values for the first parameter and at least one second subset that has, for example one or more, historical values for the first parameter, evaluating a parameter value of the received message characterizing a timeliness of a message received via the communication system based on the set.

In some examples of the present invention, security against attacks, for example so-called replay attacks in which messages are sent repeatedly, can be increased by the principle according to the disclosure.

In some examples of the present invention, the communication system is or has a bus system, for example a serial bus system, for example of the type CAN (Controller Area Network) or CAN FD (CAN Flexible Data Rate) or CAN XL. In some examples, the communication system is of a different type or is not based on CAN, for example.

In some examples of the present invention, the parameter value is a so-called freshness value, e.g. a value that characterizes the timeliness of a message that can be received via the communication system.

In some examples of the present invention, an aspect, for example a property, of a message that can be transmitted via the communication system (e.g. can be sent and/or received) is the so-called “freshness” or timeliness of the message.

In some examples of the present invention, so-called “replay” attacks can be detected or defended against using the freshness or timeliness of the message; in such attacks, an attacker e.g. records a validly sent message and sends it again at a later time via the communication system, i.e. “replays” it.

In some conventional approaches, in which for example the freshness of a message cannot be protected, the same message may be sent at least a second time by an attacker, and it will be received as valid by a conventional receiver.

In some examples of the present invention, the freshness of messages can be ensured or protected by using a freshness value, for example the first parameter described above, which characterizes the timeliness of a message that can be received via the communication system. In some examples, a freshness value or the timeliness of a message can be characterized or represented for example by means of a packet number and/or by means of a timestamp, wherein for example the packet number and/or the timestamp can be sent as part of the message.

In some examples of the present invention, the freshness value, for example the first parameter named according to the disclosure, can be checked e.g. by a receiver of the message, wherein e.g. old messages (for example messages with the same value of the first parameter that may have been sent repeatedly by an attacker) can be detected.

In some communication systems, which e.g. have a transmission medium shared between a plurality of participants (e.g. “shared medium”), for example CAN, CAN FD, or CAN XL, it can happen in some examples that packets or messages ready for transmission within a participant, e.g. bus participant, e.g. node, are re-sorted e.g. based on a priority (e.g. characterizable by a “Priority ID”) of a data frame (“frame”).

In some examples of the present invention, such a re-sorting can take place both in a source node or in a forwarding node, e.g. in some examples a node at least at times sends high-priority messages temporally before low-priority messages (e.g. due to a so-called “internal arbitration”). This means that in some examples an older, low-priority message can be sorted e.g. behind a newer, high-priority message. When for example the old, low-priority message is finally received, the receiver might already assume a new freshness value, namely based on the previous reception of the high-priority message, and so, e.g. in some conventional approaches, the receiver might erroneously discard the old message as “replayed.”

In some conventional systems, one solution approach to avoid this re-sorting problem is to allow only one priority ID, e.g. per group, e.g. per CANsec group (e.g. referred to as a “dedicated priority ID solution”).

In some examples based on the present invention, however, the mentioned set, e.g. with the first and second subset, is used, for example in the sense of a so-called “freshness window.” In some examples, for example freshness values in a certain, defined range, e.g. the freshness window, are accepted by a receiver of the message. In some examples, e.g. messages with a freshness value (e.g. value of the first parameter) outside the freshness window are not accepted or not processed.

In some examples of the present invention, the set has a first number of possible freshness values, wherein for example the first number is associated with a freshness window. For example, the first number can be characterized by the first subset.

In some examples of the present invention, e.g. a freshness window F can be used as follows. Let n be the last-received freshness value. Then, for example, every message with freshness value t is accepted if

$$n + 1 - F ⩽ t ⩽ n + 1.$$

In other words, in some examples of the present invention a received message is accepted, for example evaluated, if its freshness value t lies between or on the boundaries n+1-F, n+1 of the freshness window F.

In some examples of the present invention, the set has a second number of freshness values, for example historical freshness values, which can be characterized for example by a freshness log. For example, the second number can be characterized by the second subset. In other words, the second subset or the freshness log can contain those freshness values that have already been received with at least one message. In some examples, this makes it possible e.g. for a receiver to determine whether a message with a, or the same, freshness value has already been received, and thus whether a replay attack may be taking place.

In some examples of the present invention, the method comprises: ascertaining whether the parameter value (e.g. freshness value) of the received message is contained in the first subset, for example ascertaining whether the parameter value of the received message is contained in a, or the, freshness window, ascertaining whether the parameter value of the received message is contained in the second subset, for example ascertaining whether the parameter value of the received message is contained in a, or the, freshness log.

In some examples of the present invention, the method comprises: processing at least a portion of the received message if the ascertaining yields the result that the parameter value of the received message is contained in the first subset (e.g. is contained in the freshness window), and if the ascertaining yields the result that the parameter value of the received message is not contained in the second subset (e.g. has not already been received previously).

In some examples of the present invention, the method comprises: omitting processing of, for example discarding, the message if a) the ascertaining yields the result that that the parameter value of the received message is not contained in the first subset (e.g. lies outside the freshness window), and/or if b) the ascertaining yields the result that that the parameter value of the received message is contained in the second subset (e.g. has already been received previously).

In some examples of the present invention, the method comprises: including the parameter value of the received message in the second subset (e.g. updating the freshness log), for example if an evaluation of the parameter value of the received message, e.g. preceding the inclusion, has yielded the result that the parameter value of the received message is not contained in the second subset.

In some examples of the present invention, the method comprises: adapting the first subset, e.g. updating the freshness window, for example based on the evaluation, e.g. after receiving a message.

In some examples of the present invention, the method comprises at least one of the following elements: a) representing the second subset, for example the freshness log, by means of an information element, for example a bit field, in which each bit characterizes a possible, for example already-occurred, value for the first parameter, or b) using an information element having a plurality of bits, for example a bit field, for the second subset, for example the freshness log, wherein for example the information element, for example bit field, has 32 bits or 64 bits.

Further examples and aspects of the present invention, for example for an efficient implementation of a freshness log according to some examples, are indicated below.

In order to be able to manage, for example track, freshness values that have already been received or evaluated, e.g. “seen,” as efficiently as possible, one or more of the aspects described below can be used in some examples.

In some examples of the present invention a freshness window F has for example a size of 32 or 64 entries or fewer.

In some examples of the present invention, a freshness log can be implemented as a register (e.g. a memory register of a computing device) and/or as a variable of size “F bit,” where the memory register or variable has as many bits as the freshness log has possible entries.

In some examples of the present invention, a noting, for example marking, e.g. “tagging,” of received, e.g. “seen” freshness values t-x is then carried out, for example, by setting the x-th bit in the memory register for the freshness log (“log register”). In some examples, a freshness value “t-x” refers to a point in time t-x, for example x time units before a time t. In some examples, therefore: a) the 0th bit of the log register corresponds to the current last-seen freshness value t, b) the 1st bit corresponds to a possible seen freshness value t-1, c) the (F-1)th bit corresponds to a possible seen freshness value t-F-1. In some examples, this means that the log register has a current status as follows: [1; 0; 0; 1; 1], with the 0th bit at the left, e.g. for seen freshness values tA, tA-3, and tA-4.

In some examples of the present invention, if a new message with freshness value to is received, multiple cases can occur:
A) The new freshness value t′ is newer than the last current freshness value t. In this case, for example both the freshness window and the freshness log can be adapted. In some examples, for example a distance t′-t=x can be ascertained. The receiver can then for example update the last-seen, current freshness value, for example to t′. In some examples, the freshness log, e.g. in the form of the log register, is also updated to the new reference point t′, for example by bitshifting (moving bits) by x positions, and possibly subsequently setting the 0 bit in the log register (which then corresponds e.g. to t′).
B) The new freshness value t′ is older than the last current freshness value t. In this case, the freshness window is used in some examples. For example, the receiver calculates t-t′=y and checks whether y<F. If this is the case, e.g. t′ can be set in the log, e.g. tracked. For example, if t′ has not been seen yet, i.e. y bit in the log register is not set, in some examples the bit y can be set in the log register. In this case, e.g. the message can be considered valid (e.g. “fresh”) and/or e.g. processed further. If t′ has already been seen, i.e. the y-bit in the log register is already set, the message is recognized as a replayed message in some examples.

In some examples of the present invention, a further optimization of the log is to not include the 0th bit, which corresponds e.g. to the current last-seen freshness value, in the log, because this is e.g. already explicitly stored as the most recent freshness value. Thus, in some examples with a 32-bit log, a total of e.g. 32+1 freshness values can be managed, e.g. secured (e.g. the most recent freshness value plus the 32 freshness values t-1, . . . , t-F from the log).

In some examples of the present invention, the method comprises: receiving a, or the, message, ascertaining whether the parameter value, e.g. freshness value, of the received message is newer than a last, e.g. current, parameter value, e.g. freshness value.

In some examples of the present invention, the method comprises at least one of the following elements: a) if the parameter value, for example freshness value, of the received message is newer than the last, for example current, parameter value, updating at least a part of the set, wherein for example the updating comprises: updating the first subset and/or updating the second subset, or b) if the parameter value, for example freshness value, of the received message is not newer, for example is older, than the last, for example current, parameter value, evaluating the parameter value, for example freshness value, of the received message in relation to the first subset, wherein for example the evaluation comprises ascertaining whether the parameter value, for example freshness value, of the received message is contained in the first subset, for example in the current freshness window, or c) updating the second subset, for example the freshness log, for example if the parameter value, for example freshness value, of the received message is not already contained in the second subset, for example the freshness log, or d) concluding that there is an attack, for example a replay attack, if the parameter value, for example freshness value, of the received message is already contained in the second subset, for example the freshness log.

In some examples of the present invention, the method comprises: managing a plurality of sets of, for example, one or more values for a first parameter which characterizes a timeliness of a message that can be received via the communication system from a corresponding transmitter, wherein, for example, a set of the plurality of sets is associated with a corresponding transmitter, evaluating a parameter value of the received message characterizing a timeliness of a message received via the communication system from a specific transmitter based on the set associated with the transmitter.

In some examples of the present invention, the method comprises at least one of the following elements: a) managing a plurality of freshness windows, each of the plurality of freshness windows being associated with a corresponding transmitter, or b) managing a plurality of freshness logs, each of the plurality of freshness logs being associated with a corresponding transmitter, or c) evaluating a parameter value of the received message characterizing a timeliness of a message received via the communication system from a specific transmitter based on at least one of the following elements: c1) freshness window associated with the specific transmitter, or c2) freshness log associated with the specific transmitter.

Some examples of the present invention relate to a device for carrying out the method according to the disclosure.

Some examples of the present invention relate to a product, for example a transmitter and/or receiver, or control device, for example for a motor vehicle, comprising at least one device according to the disclosure.

Some examples of the present invention relate to a computer-readable storage medium comprising commands that, when executed by a computer, cause said computer to carry out the method according to the disclosure.

Some examples of the present invention relate to a computer program comprising commands that, when the computer program is executed by a computer, cause said computer to carry out the method according to the disclosure.

Some examples of the present invention relate to a data carrier signal that characterizes and/or transmits the computer program according to the disclosure.

Some examples of the present invention relate to a use of the method according to the disclosure and/or the device according to the disclosure and/or the product according to the disclosure and/or the computer-readable storage medium according to the disclosure and/or the computer program according to the disclosure and/or the data carrier signal according to the disclosure for at least one of the following elements: a) checking for attacks, for example replay attacks, or b) supplementing an evaluation relating to a freshness value with an evaluation relating to historical values, for example freshness values, or c) recording already ascertained or received freshness values, or d) providing individual freshness windows and/or individual freshness logs, for example for different transmitters, or e) increasing security against attacks, for example replay attacks.

Further features, possible applications and advantages of the present invention will be apparent from the following description of examples of the present invention shown in the figures. In this case, all of the features described or shown form the subject matter of the present invention individually or in any combination, irrespective of their wording or representation in the description or in the figures.

### BRIEF DESCRIPTION OF THE DRAWINGS

FIG. 1 schematically shows a simplified flow diagram according to an example embodiment of the present invention.

FIG. 2 schematically shows a simplified block diagram according to an example embodiment of the present invention.

FIG. 3 schematically shows a simplified block diagram according to an example embodiment of the present invention.

FIG. 4 schematically shows a simplified block diagram according to an example embodiment of the present invention.

FIG. 5 schematically shows a simplified block diagram according to an example embodiment of the present invention.

FIG. 6 schematically shows a simplified flow diagram according to an example embodiment of the present invention.

FIG. 7 schematically shows a simplified flow diagram according to an example embodiment of the present invention.

FIG. 8 schematically shows a simplified flow diagram according to an example embodiment of the present invention.

FIG. 9 schematically shows a simplified flow diagram according to an example embodiment of the present invention.

FIG. 10 schematically shows a simplified flow diagram according to an example embodiment of the present invention.

FIG. 11 schematically shows a simplified flow diagram according to an example embodiment of the present invention.

FIG. 12 schematically shows a simplified flow diagram according to an example embodiment of the present invention.

FIG. 13 schematically shows a simplified block diagram according to an example embodiment of the present invention.

FIG. 14 schematically shows a simplified block diagram according to an example embodiment of the present invention.

FIG. 15 schematically shows examples of uses according to an example embodiment of the present invention.

FIG. 16 schematically shows a simplified block diagram according to an example embodiment of the present invention.

### DETAILED DESCRIPTION OF EXAMPLE EMBODIMENTS

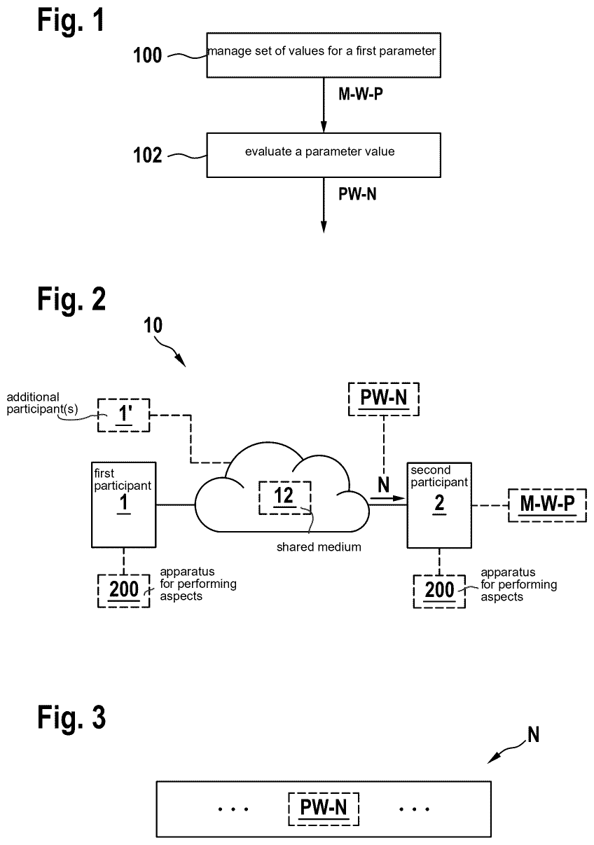

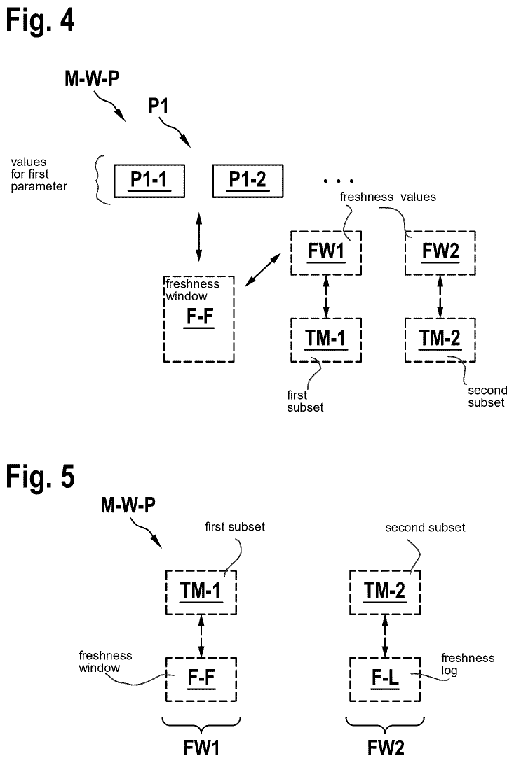

Some examples, see FIG. 1, 2, 3, 4, relate to a method, for example a computer-implemented method, for processing data associated with a communication system 10 (FIG. 2), comprising: managing 100 (FIG. 1) a set M-W-P of, for example one or more, values P1-1, P1-2, . . . (FIG. 4) for a first parameter P1 which characterizes a timeliness of a message N that can be received via the communication system 10, wherein for example the set M-W-P has at least one first subset TM-1 (FIG. 4) which has, for example one or more, possible values for the first parameter P1 and at least one second subset TM-2 which has, for example one or more, historical values for the first parameter P1, evaluating 102 (FIG. 1) a parameter value PW-N of the received message N which characterizes a timeliness of a message N received via the communication system 10 based on the set M-W-P.

In some examples, security against attacks, for example so-called replay attacks in which messages are sent repeatedly, can be increased by the principle according to the disclosure.

In some examples, FIG. 2, the communication system 10 is or has a, for example serial, bus system, for example of the type CAN (Controller Area Network) or CAN FD (CAN Flexible Data Rate) or CAN XL. In some examples, the communication system 10 is of a different type or is e.g. not based on CAN.

Element 1 according to FIG. 2 symbolizes a first participant who can send messages via the communication system 10, for example to the second participant 2. Optionally, additional participants 1′ are possible.

In some examples, FIG. 2, at least some of the participants 1, 2 can include an apparatus 200 for performing at least some aspects according to the disclosure.

In some examples, a value of the first parameter P1, e.g. parameter value, is a so-called freshness value, e.g. a value that characterizes the timeliness of a message N that can be received via the communication system 10. FIG. 3 shows as an example the message N, which has a parameter value PW-N. Optionally, the message N may contain further information, for example data, e.g. header data and/or useful data (e.g. payload), e.g. organized in one or more information elements that are not shown in FIG. 3 but are symbolized by the dots “ . . . ”.

In some examples, FIG. 2, 3, an aspect, for example a property, of a message N that can be transmitted (e.g. can be sent and/or received) via the communication system 10 is thus the so-called “freshness” or timeliness of the message N.

In some examples, using the freshness or timeliness of the message it is possible to defend against so-called “replay” attacks, in which an attacker e.g. records a validly sent message and e.g. sends it again at a later time via the communication system 10, i.e. “replays” it.

In some conventional approaches, in which for example the freshness of a message cannot be protected, the same message may be sent at least a second time by an attacker, and it will be received as valid by a conventional receiver.

In some examples, the freshness of messages can be ensured or protected by using a freshness value, for example in the form of the first parameter P1 described above (FIG. 3), which characterizes the timeliness of a message N that can be received via the communication system 10 (FIG. 2). In some examples, a freshness value or the timeliness of a message can be characterized or represented for example by means of a packet number and/or by means of a timestamp, wherein for example the packet number and/or the timestamp can be sent as part of the message. In other words, in some examples the first parameter P1 can comprise a packet number and/or time information (e.g. at least part of a timestamp).

In some examples, FIG. 2, the freshness value, for example the first parameter P1 mentioned according to the disclosure, or its value PW-N, can be checked, for example by a receiver 2 of the message N, wherein for example old messages (e.g. messages with the same value of the first parameter that may have been sent repeatedly by an attacker) can be detected.

In some communication systems, FIG. 2, which have a transmission medium (e.g. “shared medium”) 12 shared between a plurality of participants 1, 1′, 2, for example CAN, CAN FD or CAN XL, it can happen in some examples that packets or messages ready for transmission within a participant 1, e.g. bus participant, e.g. node, are re-sorted, e.g. based on a priority (e.g. characterizable by a “Priority ID”) of a data frame (“frame”).

In some examples, such a re-sorting can take place both in a source node 1 or in a forwarding node (not shown), e.g. in some examples a node at least at times sends high-priority messages temporally before low-priority messages (e.g. due to a so-called “internal arbitration”). This means that in some examples an older, low-priority message can be sorted e.g. behind a newer, high-priority message. When for example the old, low-priority message is finally received, the receiver 2 might already assume a new freshness value, namely based on the previous reception of the high-priority message, and so, e.g. in some conventional approaches, the receiver might erroneously discard the old message as “replayed.”

In some conventional systems, one solution approach to avoid this re-sorting problem is to allow only one priority ID, e.g. per group, e.g. per CANsec group (e.g. referred to as a “dedicated priority ID solution”).

In some examples based on the present disclosure, however, the mentioned set M-W-P, e.g. with the first and second subset TM-1, TM-2, is used, for example in the sense of a so-called “freshness window.” In some examples, for example freshness values in a certain, defined range, e.g. the freshness window, are accepted by a receiver 2 of the message N. In some examples, e.g. messages with a freshness value (e.g. value of the first parameter) outside the freshness window are not accepted or not processed.

In some examples, FIG. 4, 5, the set M-W-P has a first number FW1 of possible freshness values, wherein for example the first number FW1 is associated with a freshness window F-F. For example, the first number FW1 can be characterized by the first subset TM-1.

In some examples, FIG. 4, e.g. a freshness window F-F, hereinafter designated by way of example with the letter “F,” can be used as follows. Let n be the last freshness value received (e.g. by participant 2 (FIG. 2), e.g. receiver). Then, for example, every message with freshness value t is accepted if

$$n + 1 - F ⩽ t ⩽ n + 1.$$

In other words, in some examples a received message is accepted, for example evaluated, if its freshness value t lies between or on the boundaries n+1-F, n+1 of the freshness window F.

In some examples, FIG. 4, 5, the set M-W-P comprises a second number FW2 of freshness values, for example historical freshness values, which can be characterized for example by a freshness log F-L. For example, the second number FW2 can be characterized by the second subset TM-2.

In other words, in some examples, FIG. 5, the second subset TM-2 or the freshness log F-L can include those freshness values that have already been received with at least one message N (FIG. 2).

In some examples, this makes it possible e.g. for a receiver 2 to determine whether a message N with a, or the same, freshness value has already been received, and thus whether a replay attack may be taking place.

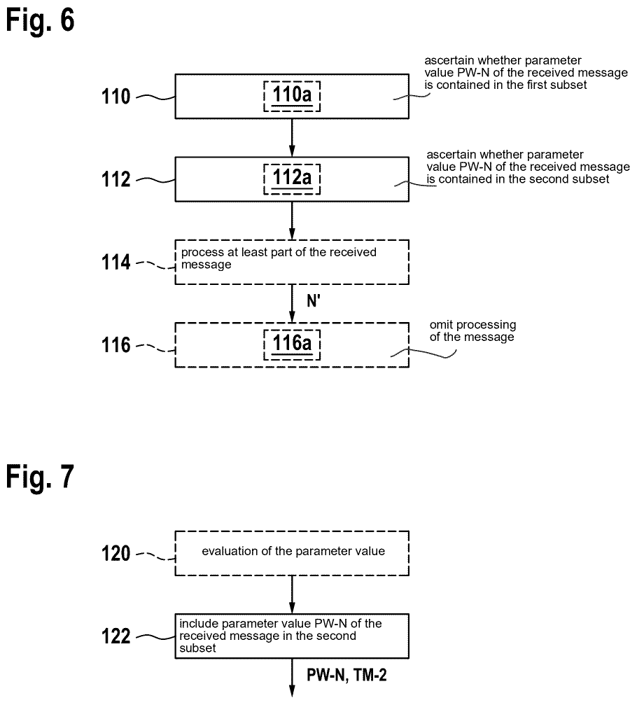

In some examples, FIG. 6, the method comprises: ascertaining 110 whether the parameter value PW-N (FIG. 2) (e.g. freshness value) of the received message N is contained in the first subset TM-1, for example ascertaining 110a whether the parameter value PW-N of the received message N is contained in a or the freshness window F-F, ascertaining 112 whether the parameter value PW-N of the received message N is contained in the second subset TM-2, for example ascertaining 112a whether the parameter value PW-N of the received message N is contained in a or the freshness log F-L.

In some examples, FIG. 6, the method comprises: processing 114 at least a part N′ of the received message N if the ascertaining 110 (or e.g. 110a) yields the result that the parameter value PW-N of the received message N is contained in the first subset TM-1 (e.g. is contained in the freshness window F-F), and if the ascertaining 112 (or e.g. 112a) yields the result that the parameter value PW-N of the received message N is not (e.g. not already) contained in the second subset TM-2 (e.g. has not already been received previously).

In some examples, FIG. 6, the method comprises: omitting 116 processing of, for example discarding 116a, the message N if a) the ascertaining 110 yields the result that the parameter value PW-N of the received message N is not contained in the first subset TM-1 (e.g. lies outside the freshness window F-F), and/or if b) the ascertaining 112 yields the result that the parameter value PW-N of the received message N is contained in the second subset TM-2 (e.g., has already been received previously).

In some examples, FIG. 7, the method comprises: including 122 the parameter value PW-N of the received message N (FIG. 2) in the second subset TM-2 (for example updating the freshness log F-L), for example if an evaluation 120 of the parameter value PW-N of the received message N, e.g. preceding the inclusion 122 (FIG. 7), has yielded the result that the parameter value PW-N of the received message N is not contained in the second subset TM-2. In some examples, this allows the freshness log F-L to be updated, so that in the future, in some examples, when a message with e.g. the same parameter value PW-N is received, it can be concluded that there is a replay attack.

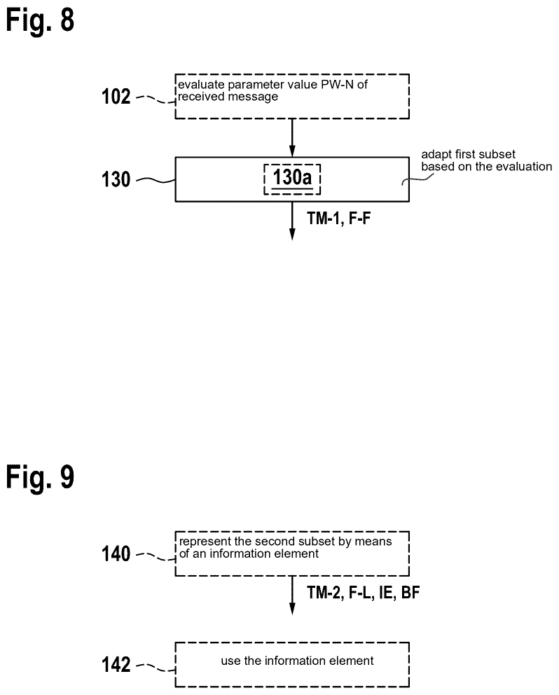

In some examples, FIG. 8, the method comprises: adapting 130 the first subset TM-1, e.g. updating 130a the freshness window F-F, e.g. based on the evaluation 102, e.g. after receiving a message N.

In some examples, FIG. 9, the method comprises at least one of the following elements: a) representing 140 the second subset TM-2, for example the freshness log F-L, by means of an information element IE, for example a bit field BF, in which each bit characterizes a possible, for example already-occurred, value for the first parameter P1, or b) using 142 an information element IE having a plurality of bits, for example bit field BF, for the second subset TM-2, for example the freshness log F-L, wherein for example the information element IE, for example bit field BF, has 32 bits or 64 bits.

Below, further examples and aspects are indicated, for example for an efficient implementation of a freshness log F-L, according to some examples.

In order to be able to manage, for example track, freshness values that have already been received or evaluated, e.g. “seen,” as efficiently as possible, one or more of the aspects described below can be used in some examples.

In some examples, a freshness window F (see also e.g. the reference symbol F-F according to FIG. 4) has for example a size of 32 or 64 entries, or fewer.

In some examples, a freshness log F-L can be implemented as a register (e.g. a memory register of a computing device) and/or as a variable of size “F bit,” where the memory register or variable has as many bits as the freshness log has possible entries.

In some examples, a noting, for example marking, e.g. “tagging,” of received, e.g. “seen” freshness values t-x is then carried out, for example, by setting the x-th bit in the memory register for the freshness log F-L (“log register”). In some examples, therefore: a) the 0th bit of the log register corresponds to the current last-seen freshness value t, b) the 1st bit corresponds to a possible seen freshness value t-1, c) the (F-1)th bit corresponds to a possible seen freshness value t-F-1. In some examples, this means that the log register has a current status as follows: [1; 0; 0; 1; 1], with the 0th bit at the left, e.g. for seen freshness values tA, tA-3, and tA-4.

In some examples, if a new message with freshness value to is received, multiple cases can occur:
A) The new freshness value t′ is newer than the last current freshness value t. In this case, for example both the freshness window F-F and the freshness log F-L can be adapted. In some examples, for example a distance t′-t=x can be ascertained. The receiver 2 (FIG. 2) can then for example update the last-seen, current freshness value, for example to t′. In some examples, the freshness log F-L, e.g. in the form of the log register, is also updated to the new reference point t′, for example by bitshifting (moving bits) by x positions, and possibly subsequently setting the 0 bit in the log register (which then corresponds e.g. to t′).
B) The new freshness value t′ is older than the last current freshness value t. In this case, the freshness window F-F, or F, is used in some examples. For example, the receiver 2 (FIG. 2) calculates t-t′=y and checks whether y<F. If this is the case, e.g. t′ can be set in the log, e.g. tracked. For example, if t′ has not been seen yet, i.e. y bit in the log register is not set, in some examples the bit y can be set in the log register. In this case, e.g. the message can be considered valid (e.g. “fresh”) and/or e.g. processed further. If t′ has already been seen, i.e. the y-bit in the log register is already set, the message is recognized as a replayed message in some examples.

In some examples, a further optimization of the log is to not include the 0th bit, which corresponds e.g. to the current last-seen freshness value, in the log, because this is e.g. already explicitly stored as the most recent freshness value. Thus, in some examples with a 32-bit log, a total of e.g. 32+1 freshness values can be managed, e.g. secured (e.g. the most recent freshness value plus the 32 freshness values t-1, . . . , t-F from the log).

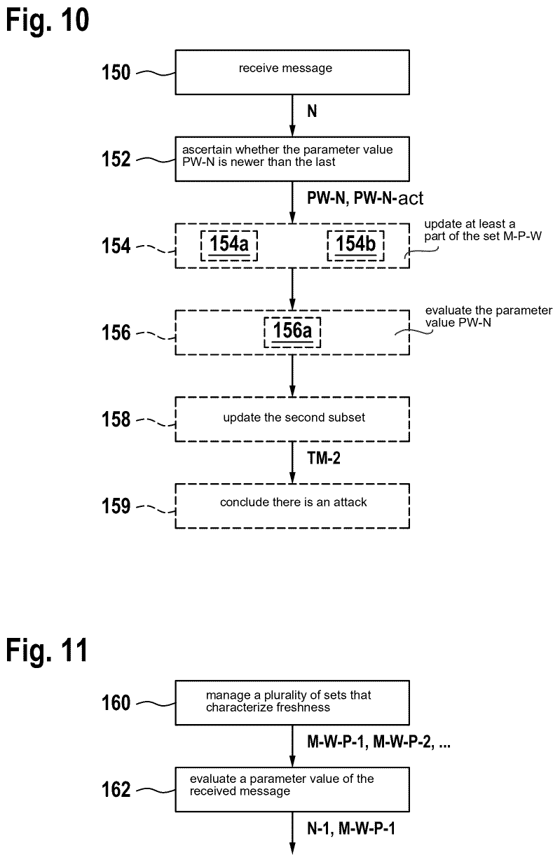

In some examples, FIG. 10, the method comprises: receiving 150 a, or the, message N, ascertaining 152 whether the parameter value PW-N, e.g. freshness value, of the received message N is newer than a last, e.g. current, parameter value PW-N-act, e.g. freshness value.

In some examples, FIG. 10, the method comprises at least one of the following elements: a) if the parameter value PW-N, for example freshness value, of the received message N is newer than the last, for example current, parameter value PW-N-act, updating 154 at least a part of the set M-P-W (FIG. 4), wherein for example the updating 154 comprises: updating 154a the first subset TM-1, and/or updating 154b the second subset TM-2, or b) if the parameter value PW-N, for example freshness value, of the received message N is not newer, for example is older, than the last, for example current, parameter value PW-N-act, evaluating 156 the parameter value PW-N, for example freshness value, of the received message N in relation to the first subset TM-1, wherein for example the evaluating 156 comprises ascertaining 156a whether the parameter value PW-N, for example freshness value, of the received message N is contained in the first subset TM-1, for example in the current freshness window F-F (or “F”), or c) updating 158 the second subset TM-2, for example the freshness log F-L, for example if the parameter value PW-N, for example freshness value, of the received message N is not already contained in the second subset TM-2, for example the freshness log F-L, or d) concluding 159 that there is an attack, for example a replay attack, if the parameter value PW-N, for example freshness value, of the received message N is already contained in the second subset TM-2, for example the freshness log F-L.

In some examples, FIG. 11, the method comprises: managing 160 a plurality of sets M-W-P-1, M-W-P-2, . . . of, for example, one or more values for a first parameter P1 that characterizes a timeliness (e.g. freshness) of a message N that can be received via the communication system 10 from a corresponding transmitter 1, 1′, . . . , for example a set M-W-P-1 of the plurality of sets being associated with a corresponding transmitter 1, evaluating 162 a parameter value of the received message N-1 characterizing a timeliness of a message N-1 received via the communication system 10 from a specific transmitter 1 based on the corresponding set M-W-P-1 associated with the transmitter 1.

In some examples, FIG. 2, for example at least some possible transmitters 1, 1′, . . . of messages, e.g. to a receiver 2, can each be assigned a channel, and the receiver 2 can for example manage, for example use, individual sets M-W-P-1, M-W-P-2, . . . for at least some channels in each case, for example each with corresponding subsets TM-1, TM-2, e.g. associated with or characterizing corresponding freshness windows or freshness logs, e.g. to check messages received from the corresponding transmitters 1, 1′, for example based on the principle according to the disclosure.

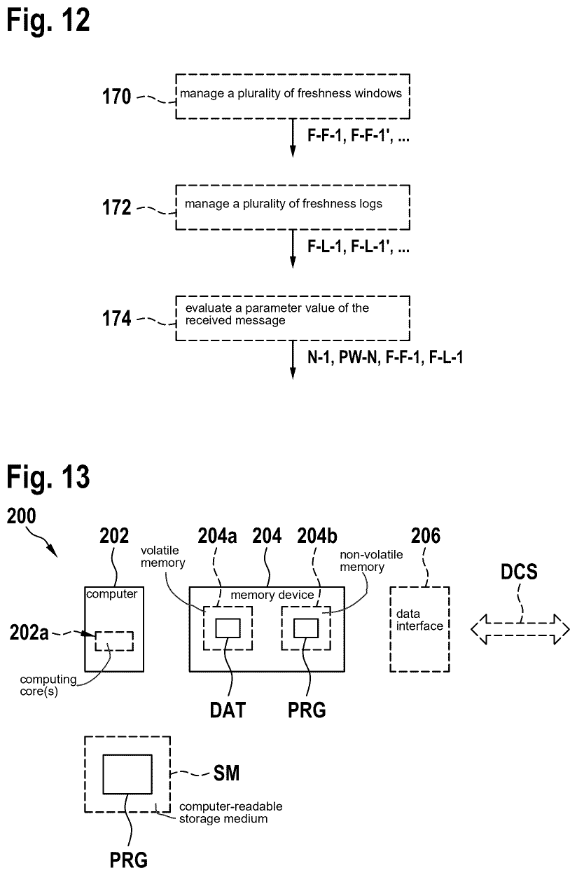

In some examples, FIG. 12, the method comprises at least one of the following elements: a) managing 170 a plurality of freshness windows F-F-1, F-F-1′, . . . , each of the plurality of freshness windows F-F-1, F-F-1′, . . . being associated with a corresponding transmitter 1, 1′, . . . (FIG. 2), or b) managing 172 (FIG. 12) a plurality of freshness logs F-L-1, F-L-1′, . . . , each of the plurality of freshness logs F-L-1, F-L-1′, . . . being associated with a corresponding transmitter 1, 1′, . . . , or c) evaluating 174 a parameter value PW-N of the received message N-1 characterizing a timeliness of a message N-1 received via the communication system 10 from a specific transmitter 1 based on at least one of the following elements: c1) freshness window F-F-1 associated with the specific transmitter 1, or c2) freshness log F-L-1 associated with the specific transmitter 1.

Some examples, FIG. 13, relate to a device 200 for carrying out the method according to the disclosure. In some examples, at least one of the participants 1, 1′, 2 according to FIG. 2 can have the device 200 or a corresponding functionality.

In some examples, FIG. 13, it is provided that the device 200 comprises: a computing device (“computer”) 202 having at least one computing core 202a, a memory device 204 associated with the computing device 202 for at least temporarily storing at least one of the following elements: a) data DAT (e.g. data associated with the message N, e.g. the first parameter or freshness value, and/or data associated with the set M-W-P or the subsets TM-1, TM-2), b) computer program PRG, for example for carrying out the method according to the disclosure.

In further examples, FIG. 13, the memory device 204 has a volatile memory (e.g. working memory (RAM)) 204a, and/or a non-volatile (NVM) memory (e.g. flash EEPROM) 204b, or a combination of these or with other types of memory not explicitly mentioned.

In further examples, FIG. 13, the device 200 is designed as a hardware circuit, for example a pure hardware circuit (not shown).

Further examples, FIG. 13, relate to a computer-readable storage medium SM comprising commands PRG that, when executed by a computer 202, cause said computer to carry out the method according to the disclosure.

Further examples, FIG. 13, relate to a computer program PRG comprising commands that, when the program PRG is executed by a computer 202, cause said computer to carry out the method according to the disclosure.

Further examples, FIG. 13, relate to a data carrier signal DCS that characterizes and/or transmits the computer program PRG according to the disclosure. The data carrier signal DCS can be received, for example, via an optional data interface 206 of the device 200. For example, the data interface 206 can enable a connection to the communication system 10.

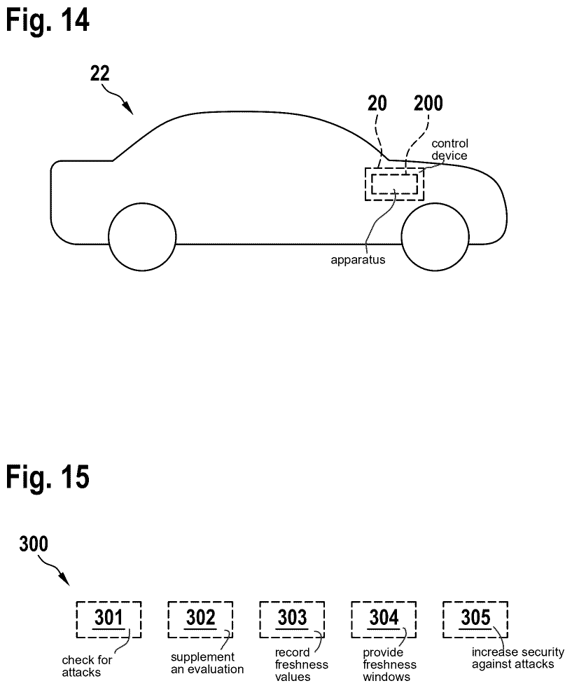

Some examples, FIG. 2, 14, relate to a product, for example transmitter 1, 1′ and/or receiver 2 (and/or transceiver), or control device 20 (FIG. 14), for example for a motor vehicle 22, comprising at least one device 200 according to the disclosure.

Some examples, FIG. 15, relate to a use 300 of the method according to the disclosure and/or the device 200 according to the disclosure and/or the product 1, 1′, 2, 20 according to the disclosure and/or the computer-readable storage medium SM according to the disclosure and/or the computer program PRG according to the disclosure and/or the data carrier signal DCS according to the disclosure for at least one of the following elements: a) checking 301 for attacks, for example replay attacks, or b) supplementing 302 an evaluation relating to a freshness value with an evaluation relating to historical values, for example freshness values, or c) recording 303 already ascertained or received freshness values, or d) providing 304 individual freshness windows F-F, F-F-1, . . . and/or individual freshness logs F-L, F-L-1, . . . , for example for different transmitters 1, 1′, or e) increasing 305 security against attacks, for example replay attacks.

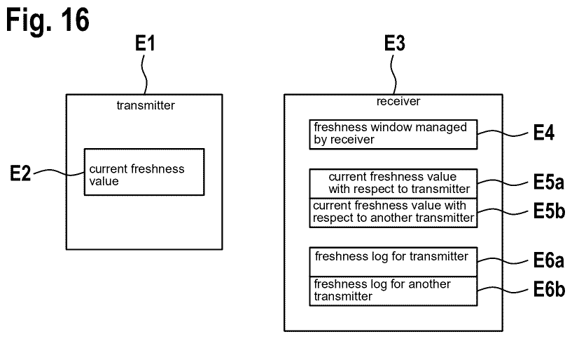

FIG. 16 schematically shows aspects according to some examples. Element E1 symbolizes a transmitter, and element E2 symbolizes a current freshness value, e.g. “t,” which the transmitter E1 adds to a message N to be sent to a receiver E3, e.g. at least similar to the parameter value PW-N with respect to the message N according to FIG. 3.

Element E4 of FIG. 16 symbolizes a freshness window managed by the receiver E3, e.g. “F,” which can be characterized by a first subset TM-1 of possible parameter values. Element E5a symbolizes a current freshness value, e.g. “tA,” with respect to the transmitter E1 (e.g. ascertainable based on a message previously received from the transmitter E1), and element E5b symbolizes a current freshness value, e.g. “tB,” in relation to another transmitter (not shown, e.g. ascertainable based on a message previously received from the other transmitter). Optionally, in some examples, the receiver E3 can also manage additional current freshness values associated with other possible transmitters (not shown).

Element E6a of FIG. 16 symbolizes a freshness log for the transmitter E1, e.g. having the values: {tA, tA-3, tA-4}. Element E6b of FIG. 16 symbolizes a freshness log for the other (not shown) transmitter, e.g. having the values: {tC, tC-1, tC-4}.

When receiving a message from the transmitter E1 according to FIG. 16, e.g. with the freshness value “t” contained therein, the receiver E3 can for example perform at least one of the following aspects:
a) checking whether the freshness value “t” is contained in the current freshness window, e.g. according to t=>tA-F, where for example the current freshness value is read from block E5a, where for example the current freshness window F is read from block E4,
b) checking whether the freshness value “t” is not contained in the freshness log E6a, i.e. “t” is not contained in the list {tA, tA-3, tA-4}.

If both of the above points a), b) are fulfilled, the message with the freshness value “t” can be considered as in fact being “fresh” and e.g. can be processed. Optionally, the current freshness value E5a can be updated, e.g. by setting it to “t”, e.g. if t>tA. Optionally, the freshness log E6a can be updated.

If at least one of the two above points a), b) is not fulfilled, the received message N will e.g. not be processed.

In some examples, the principle according to the disclosure makes it possible to reduce or eliminate a risk of a replay attack when using a freshness window.

In some examples, the principle according to the disclosure enables a set of possible freshness values to be tracked, e.g. in the region of the freshness window F-F, or “F,” e.g. to track, according to {n+1−F,n+1−F+1, . . . , n+1−F+(F−1)=n,n+1}, which freshness values have already been seen, e.g. by a receiver 2 or E3. In some examples, an already-seen freshness value in a further received message is thus regarded as “replayed.”

In some examples, a participant, e.g. transmitter 1, 1′, manages, e.g. internally, a current freshness value t; see also reference symbol E2 according to FIG. 16.

In some examples, a participant, e.g. receiver 2, manages, e.g. internally, the described freshness window F (possibly multiple windows, e.g. a separate window per receiving channel, i.e. per other transmitting participant, e.g. node), a last-seen, current freshness value per receiving channel (e.g. “tA” for the last received freshness value E5a from transmitter E1 according to FIG. 16 and “tC” for the last-received freshness value E5b from the other transmitter, and one freshness log E6a, E6b for each receiving channel.

In some examples, the freshness logs E6a, E6b contain for example the last freshness values seen by the corresponding receiver E3, which are e.g. still within the freshness window F; see block E4 in FIG. 16, i.e. a maximum of e.g.

$$\{ t , t - 1 , … , t - F \} .$$

What is claimed is:

1. A computer-implemented method for processing data associated with a communication system, the method comprising the following steps:
managing a set of values for a first parameter which characterizes a timeliness of a message that can be received via the communication system, the set has at least one first subset which has possible values for the first parameter and at least one second subset which has historical values for the first parameter;
evaluating a parameter value of a received message which characterizes a timeliness of the message received via the communication system based on the set.

2. The method according to claim 1, wherein:
a) the parameter value is a freshness value, and/or
b) the set has:
b1) a first number of possible freshness values associated with a freshness window, and/or
b2) a second number historical freshness values,
which can be characterized by a freshness log.

3. The method according to claim 1, further comprising:
ascertaining whether the parameter value of the received message is contained in the first subset,
ascertaining whether the parameter value of the received message is contained in the second subset.

4. The method according to claim 3, further comprising:
processing at least a part of the received message when the ascertaining yields a result that the parameter value of the received message is contained in the first subset, and when the ascertaining yields a result that the parameter value of the received message is not contained in the second subset.

5. The method according to claim 3, further comprising:
omitting a processing of the message when a) the ascertaining yields a result that the parameter value of the received message is not contained in the first subset, and/or when b) the ascertaining yields a result that the parameter value of the received message is contained in the second subset.

6. The method according to claim 1, further comprising: including the parameter value of the received message in the second subset when an evaluation of the parameter value of the received message has yielded a result that the parameter value of the received message is not contained in the second subset.

7. The method according to claim 2, further comprising:
adapting the first subset including updating the freshness window based on the evaluation.

8. The method according to claim 2, further comprising at least one of the following elements:
a) representing the freshness log using an information element in which each bit characterizes a possible, already-occurred, value for the first parameter, or
b) using an information element having a plurality of bits for the freshness log, wherein the information element has 32 bits or 64 bits.

9. The method according to claim 1, further comprising:
ascertaining whether the parameter value of the received message is newer than a current freshness value.

10. The method according to claim 9, comprising at least one of the following elements:
a) when the parameter value of the received message is newer than the current freshness value, updating at least a part of the set, wherein the updating includes updating the first subset and/or updating the second subset, or
b) when the parameter value of the received message is not newer than the current freshness value, evaluating the parameter value of the received message in relation to the first subset, wherein the evaluation includes ascertaining whether the parameter value of the received message is contained in the first subset, or
c) updating the second subset when the parameter value of the received message is not already contained in the second subset, or
d) concluding that there is an attack when the parameter value of the received message is already contained in the second subset.

11. The method according to claim 1, further comprising:
managing a plurality of sets of values for the first parameter which characterizes a timeliness of a message that can be received via the communication system from a corresponding transmitter, wherein a set of the plurality of sets is associated with the corresponding transmitter;
evaluating the parameter value of the received message characterizing a timeliness of a message received via the communication system from the corresponding transmitter based on the set associated with the corresponding transmitter.

12. The method according to claim 1, further comprising at least one of the following elements:
a) managing a plurality of freshness windows, each respective freshness window of the plurality of freshness windows being associated with a respective transmitter, or
b) managing a plurality of freshness logs, each respective freshness log of the plurality of freshness logs being associated with a respective transmitter, or
c) evaluating a parameter value of the received message characterizing a timeliness of a message received via the communication system from a specific transmitter based on at least one of the following elements:
c1) a freshness window associated with the specific transmitter, or
c2) a freshness log associated with the specific transmitter.

13. A device configured to process data associated with a communication system, the device configured to:
manage a set of values for a first parameter which characterizes a timeliness of a message that can be received via the communication system, the set has at least one first subset which has possible values for the first parameter and at least one second subset which has historical values for the first parameter; and
evaluate a parameter value of a received message which characterizes a timeliness of the message received via the communication system based on the set.

14. The device according to claim 13, wherein the device is included in a transmitter and/or a receiver and/or a control device for a motor vehicle.

15. A non-transitory computer-readable storage medium on which are stored commands for processing data associated with a communication system, the commands, when executed by a computer, causing the computer to perform the following steps:
managing a set of values for a first parameter which characterizes a timeliness of a message that can be received via the communication system, the set has at least one first subset which has possible values for the first parameter and at least one second subset which has historical values for the first parameter;
evaluating a parameter value of a received message which characterizes a timeliness of the message received via the communication system based on the set.

16. The method according to claim 1, wherein the method is used for:
a) checking for replay attacks, or
b) supplementing an evaluation relating to a freshness value with an evaluation relating to historical values, or
c) recording already ascertained or received freshness values, or
d) providing individual freshness windows and/or individual freshness logs for different transmitters, or
e) increasing security against replay attacks.
